(19) United States
(12) Patent Application Publication
(10) Pub. No.: US 2026/0101210 A1
(43) Pub. Date: Apr. 9, 2026

(54) METHOD OF SERVING ENERGY INFORMATION IN NETWORK AND DEVICES FOR PERFORMING THE SAME

(71) Applicant: Electronics and Telecommunications Research Institute, Daejeon (KR)

(72) Inventors: Jonggwan AN, Daejeon (KR); Myung Ki SHIN, Daejeon (KR)

(73) Assignee: Electronics and Telecommunications Research Institute, Daejeon (KR)

(21) Appl. No.: 19/346,967

(22) Filed: Oct. 1, 2025

(30) Foreign Application Priority Data
Oct. 4, 2024 (KR) 10-2024-0135109
Oct. 22, 2024 (KR) 10-2024-0145190
Nov. 8, 2024 (KR) 10-2024-0158566
Mar. 28, 2025 (KR) 10-2025-0040250
Sep. 10, 2025 (KR) 10-2025-0129041

(51) Int. Cl. H04W 24/08; H04W 28/02; H04W 76/10

(52) U.S. Cl. CPC H04W 24/08; H04W 28/0268; H04W 76/10

(57) ABSTRACT

A method of serving energy information in a network and devices for performing the same are provided. The method includes collecting first user equipment (UE)-related energy consumption information from operation, administration, and maintenance (OAM), collecting second UE-related energy consumption information from a fifth generation core (5GC) network function (NF), calculating energy consumption information in a unit of required granularities based on the first UE-related energy consumption information and the second UE-related energy consumption information, receiving a request for energy information from an NF consumer, and providing the energy consumption information in the unit of required granularities to the NF consumer.

### CROSS-REFERENCE TO RELATED APPLICATION

This application claims the benefit of Korean Patent Application No. 10-2024-0135109 filed on Oct. 4, 2024, Korean Patent Application No. 10-2024-0145190 filed on Oct. 22, 2024, Korean Patent Application No. 10-2024-0158566 filed on Nov. 8, 2024, Korean Patent Application No. 10-2025-0040250 filed on Mar. 28, 2025, and Korean Patent Application No. 10-2025-0129041 filed on Sep. 10, 2025, in the Korean Intellectual Property Office, the entire disclosures of which are incorporated herein by reference for all purposes.

### BACKGROUND

### 1. Field of the Invention

The following disclosure relates to a method of serving energy information in a network and devices for performing the same.

### 2. Description of the Related Art

The commercialization of fifth generation (5G) achieves innovation and economic gains using 5G technology across industries, and research for sixth generation (6G) technology has begun to accelerate continuous technological evolution and innovation.

Meanwhile, a network energy-saving technology beyond a low-power operating method of a terminal draws attention to respond to climate change and pursue sustainable development. 5G and 6G desire to adopt energy technologies according to the global carbon-neutral policy.

The above description has been possessed or acquired by the inventor(s) in the course of conceiving the present disclosure and is not necessarily an art publicly known before the present application is filed.

### SUMMARY

An embodiment may provide a method of providing energy information in a network.

An embodiment may provide a method of finding and selecting an energy recognition network function to efficiently find and select a network function according to a network energy consumption situation to achieve energy saving and efficiency in a fifth generation (5G) or sixth generation (6G) system.

However, the technical aspects are not limited to the aforementioned aspects, and other technical aspects may be present.

A method of serving energy information in a network according to an embodiment includes collecting first user equipment (UE)-related energy consumption information from operation, administration, and maintenance (OAM), collecting second UE-related energy consumption information from a fifth generation core (5GC) network function (NF), calculating energy consumption information in a unit of required granularities based on the first UE-related energy consumption information and the second UE-related energy consumption information, receiving a request for energy information from an NF consumer, and providing the energy consumption information in the unit of required granularities to the NF consumer.

The 5GC NF includes at least one of a user plane function (UPF) and a session management function (SMF).

A reporting period from the OAM is the same as a reporting period from the 5GC NF.

The unit of required granularities includes UE, a protocol data unit (PDU) session, and a quality of service (QoS) flow.

The request includes a reporting period and a reporting frequency.

A device for serving energy information in a network according to an embodiment includes at least one processor including processing circuitry, and memory storing instructions, wherein the instructions, when executed individually or collectively by the at least one processor, cause the device to collect first UE-related energy consumption information from OAM, collect second UE-related energy consumption information from a 5GC NF, calculate energy consumption information in a unit of required granularities based on the first UE-related energy consumption information and the second UE-related energy consumption information, receive a request for energy information from an NF consumer, and provide energy consumption information in the unit of required granularities to the NF consumer.

The 5GC NF includes at least one of a UPF and an SMF.

A reporting period from the OAM is the same as a reporting period from the 5GC NF.

The unit of required granularities includes UE, a PDU session, and a QoS flow.

The request includes a reporting period and a reporting frequency.

An embodiment may provide energy information in a network and may achieve energy saving and efficiency improvement by efficiently and smartly finding and selecting a network function according to an energy consumption situation in the network.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a network system according to an embodiment;

FIG. 2 is an example of an architecture representing a part of a network system using a reference point representation according to an embodiment;

FIG. 3 is a diagram illustrating an energy information function (EIF) service according to an embodiment;

FIG. 4 is a diagram illustrating a process of providing energy consumption information according to an embodiment;

FIG. 5 is a diagram illustrating an example of the use of energy consumption information according to an embodiment;

FIG. 6 is a diagram illustrating another example of the use of energy consumption information according to an embodiment;

FIG. 7 is a diagram illustrating a gNodeB (gNB) identifier (ID) update trigger for an EIF when changing a network according to an embodiment;

FIG. 8 is a diagram illustrating a user plane function (UPF) ID update trigger for an EIF when changing a network according to an embodiment; and

FIG. 9 is a schematic block diagram of a device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular form is intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to one embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, the term “unit” is not limited to software or hardware. The “unit” may be configured to be in an addressable storage medium or configured to operate one or more processors. For example, the “unit” may include components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like elements and a repeated description related thereto will be omitted.

Terms used herein to identify a connection node, to indicate network entities, to indicate messages, to indicate an interface among network entities, to indicate various pieces of identification information are examples for ease of description. Thus, terms are not limited to terms described later in this disclosure and other terms referring to a subject having the equivalent technical meaning may be used.

Herein, for ease of description, of the currently existing communication standards, terms and names defined by long-term evolution (LTE) and new radio (NR) standards, which are the latest standards defined by the third generation partnership project (3GPP) association, are used. However, embodiments described hereinafter are not limited to the terms and names and a system in compliance with other standards may be applicable in the same manner.

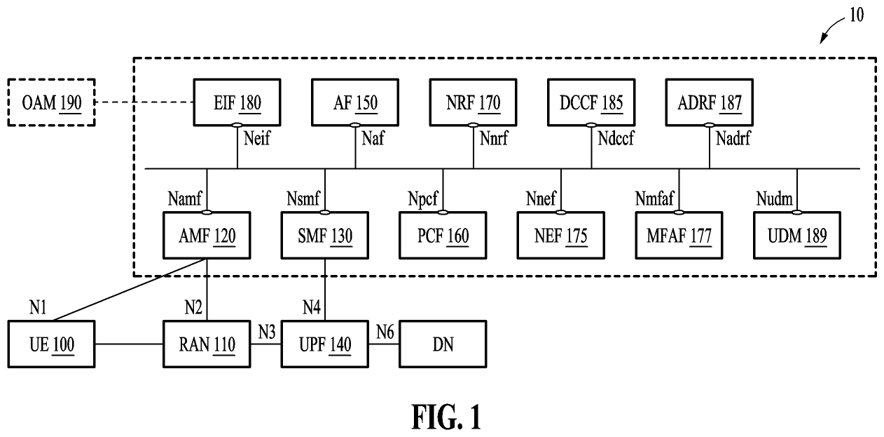

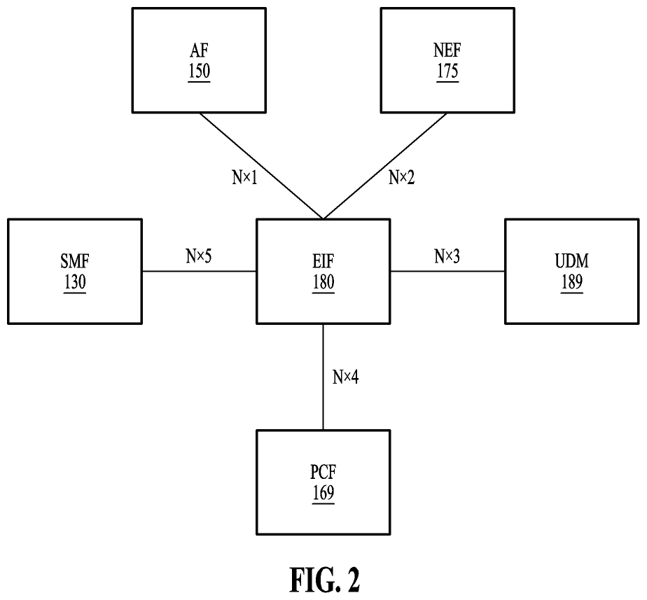

FIG. 1 illustrates a network system according to an embodiment, and FIG. 2 is an example of an architecture representing a part of a network system using a reference point representation according to an embodiment.

FIG. 1 illustrates a network system 10 (e.g., a fifth generation (5G) network system, a sixth generation (6G) network system, or a 5G/6G network system) according to an embodiment. The network system 10 of FIG. 1 may represent a non-roaming reference architecture using a service-based interface. The network system 10 may include network functions (NFs) (e.g., NFs illustrated in FIG. 2) with enhanced functions to support energy efficiency and energy saving functions. FIG. 2 may represent a non-roaming reference architecture that shows how various NFs interact with each other for energy efficiency and energy saving using a reference point representation. As illustrated in FIG. 2, FIG. 2 may represent only a portion where an energy information function (EIF) 180 directly interfaces with other NFs (e.g., an application function (AF) 150, a network exposure function (NEF) 175, a unified data management (UDM) 189, a session management function (SMF) 130, and a policy control function (PCF) 160).

The network system 10 may include a plurality of entities 100 to 190. User equipment or a user terminal (UE) 100 may access a 5G core network via a radio access network (RAN) 110 (e.g., gNodeB (gNB)). The RAN 110 may refer to a base station that provides a wireless communication function to the UE 100. Operation, administration, and maintenance (OAM) 190 may be a system for managing a terminal and a network.

A unit that each function provided by the network system 10 performs may be defined as an NF. The NF may include an access and mobility management function (AMF) 120, the SMF 130, a user plane function (UPF) 140, the AF 150, the PCF 160, a network repository function (NRF) 170, the NEF 175, a management data analytics function (MDAF) 177, the EIF 180, a data collection coordination function (DCCF) 185, an analytics data repository function (ADRF) 187, and the UDM 189. The AMF 120 may manage network access and mobility of a terminal, the SMF 130 may perform a function related to a session, the UPF 140 may handle transmission of user data, and the AF 150 may perform a function to communicate with a 5G core (5GC) to provide an application service. The PCF 160 may manage a policy, the NRF 170 may handle a function to store state information of NFs and process a request to find an accessible NF for other NFs.

The EIF 180 may calculate energy consumption information by analyzing data collected by a network (e.g., the 5G network) for network energy efficiency and energy saving and may provide (e.g., expose) the energy consumption information. The EIF 180 may collect, store, or analyze information from the network. The EIF 180 may collect information from the OAM 190, an NF (e.g., the AMF 120, the SMF 130, the UPF 140, the PCF 160, the NRF 170, the NEF 175, the MDAF 177, the DCCF 185, the ADRF 187, and/or the UDM 189) included in the network, the UE 100, or the AF 150. The EIF 180 may provide the energy consumption information to an unspecified NF (e.g., the AMF 120, the SMF 130, the UPF 140, the PCF 160, the NRF 170, the NEF 175, the MDAF 177, the DCCF 185, the ADRF 187, and/or the UDM 189), the OAM 190, the UE 100, or the AF 150. The energy consumption information may be independently used by each NF (e.g., the AMF 120, the SMF 130, the UPF 140, the PCF 160, the NRF 170, the NEF 175, the MDAF 177, the DCCF 185, the ADRF 187, and/or the UDM 189), the OAM 190, the UE 100, or the AF 150.

The network 10 may support a selection and renegotiation process of a background data transfer (BDT) policy by adopting energy-related information in the network system 10. The PCF 160 may determine the policy based on the energy consumption information. In addition, the PCF 160 may trigger BDT policy renegotiation with the AF 150 based on the energy consumption information.

Subscription data (e.g., UE subscription data) to the UE 100 may be used by a Nudm_SubscriberDataManagement service. The UE subscription data may include access and mobility subscription data, slice selection subscription data, SMF selection subscription data, SMS management subscription data, and SMS subscription data. In addition, the UE subscription data may include energy-related subscription data. The energy-related subscription data for UPF selection may be shown as Table 1.

TABLE 1

| Subscription data type | Field | Description |
|---|---|---|
| Energy-related | Energy available | Indicates the amount of |
| subscription data | credit | energy a user can consume |
| | | in the network |
| | Energy saving | Indicates the priority |
| | priority | between network |
| | | optimization, performance, |
| | | and energy efficiency or |
| | | savings |
| | Proportion of | Indicates the preferred |
| | renewable | proportion of renewable |
| | energy usage | energy to use when it is |
| | | available |

The subscription data to the UE 100 (e.g., the UE subscription data) may include an energy saving indicator indicating that the UE 100 is a target of a network energy saving operation.

The AMF 120 may receive the energy saving indicator in the UE subscription data. The AMF 120 may forward the energy saving indicator to a next generation (NG)-RAN and the PCF 160. The energy saving indicator may be used to select an energy saving strategy for the UE 100 in the network system 10.

During an AM policy association establishment procedure, the AMF 120 may send the energy saving indicator to the PCF 160. The PCF 160 may determine the policy by reusing an existing parameter according to an operator policy based on the energy saving indicator.

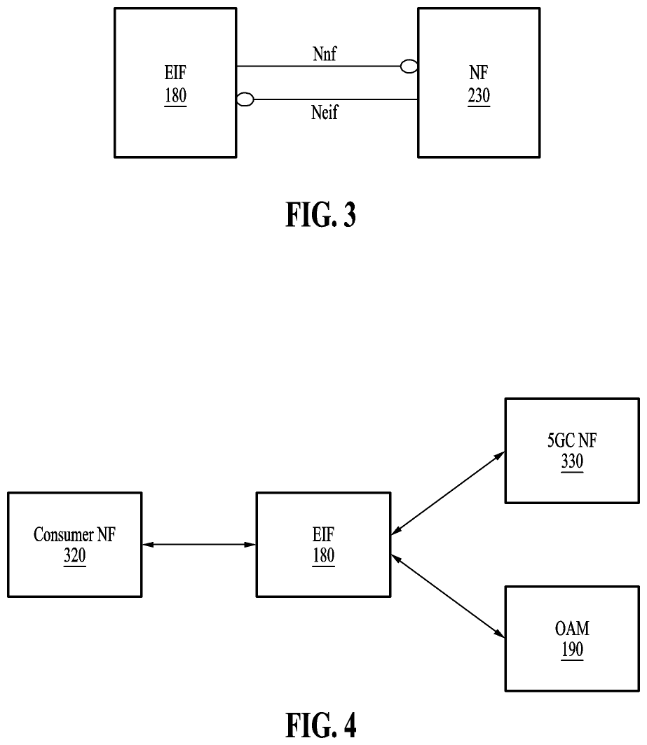

FIG. 3 is a diagram illustrating an EIF service according to an embodiment.

The EIF 180 may provide an EIF service (or NF service) to an NF 230. The EIF service (or NF service) may include a service, such as energy consumption information exposure (Neif_EventExposure). The EIF services provided by the EIF 180 are shown in Table 2.

TABLE 2

| Service name | Description |
|---|---|
| Neif_EventExposure | Enables other NF consumers to subscribe |
| | to the energy consumption information |

The EIF 180 may provide (e.g., expose) the energy consumption information to the NF 230 in response to a request from the NF 230. In addition, the EIF 180 may calculate the energy consumption information in response to the request from the NF 230 and may provide the energy consumption information to the NF 230.

The EIF 180 may support calculation of energy-related information (e.g., the energy consumption information and renewable energy information) of user plane communication.

The EIF 180 may collect data from the OAM 190 and/or 5GC NFs to support the calculation of the energy-related information. For example, the data may be UE-related energy consumption information. The EIF 180 may calculate the energy-related information based on the collected data. The EIF 180 may calculate the energy-related information in the unit of required granularities (e.g., the UE, a protocol data unit (PDU) session, and/or a quality of service (QoS) flow). The EIF 180 may expose the calculated energy-related information to the NF 230 (e.g., an authorized consumer).

Hereinafter, an example of an operation of calculating energy consumption (e.g., the energy-related information) for the required granularities by the EIF is described.

The EIF 180 may collect data from the OAM and/or 5GC NFs. The data may include energy (e.g., E_{UPF}) consumed in the UPF 140, energy (e.g., E_{gNB}) consumed in a gNB (e.g., the RAN 110), a data volume consumed in the UPF 140 that serves the UE 100, and a data volume consumed in the gNB (e.g., the RAN 110) that serves the UE 100.

The EIF 180 may obtain energy (e.g., E_{UPF}) consumed in the UPF 140 and energy (e.g., E_{gNB}) consumed in the gNB. The energy may refer to a total energy value or total energy consumption. The energy (e.g., E_{UPF}) consumed in the UPF 140 and/or the energy (e.g., E_{gNB}) consumed in the gNB may be a value within a time window T.

The EIF 180 may obtain the data volume consumed in the UPF 140 that serves the UE 100. For example, the data volume consumed by the UPF 140 may include a data volume (e.g., DV_{UE,UPF}) consumed in the UPF 140 by the UE 100 during the time interval T, a data volume (e.g., DV_{Session,UPF}) consumed in the UPF 140 by an UE PDU session during the time interval T, a data volume (e.g., DV_{Flow,UPF}) consumed in the UPF 140 by a QoS flow during the time interval T, and the total data volume (e.g., DV_{UPF}) in the UPF 140.

In addition, the EIF 180 may obtain the data volume consumed in the gNB (e.g., the RAN 110) that serves the UE 100. For example, the data volume consumed in the gNB (e.g., the RAN 110) may include a data volume (e.g., DV_{UE,gNB}) consumed in the gNB (e.g., the RAN 110) by the UE 100 during the time interval T, a data volume (e.g., DV_{Session,gNB}) consumed in the gNB (e.g., the RAN 110) by the UE PDU session during the time interval T, a data volume (e.g., DV_{Flow,gNB}) consumed in the gNB (e.g., the RAN 110) by the QoS flow during the time interval T, and the total data volume (e.g., DV_{gNB}) in the gNB (e.g., the RAN 110).

The EIF 180 may obtain the energy consumption information at required granularities based on the information described above.

The EIF 180 may calculate the energy consumption information about the energy consumed in the gNB (e.g., the RAN 110) during the time interval T for the UE, the PDU session, and the QoS flow through Equation 1.

$${E}_{UE , gNB} = {E}_{gNB} \frac{{DV}_{UE , gNB}}{{DV}_{gNB}} \qquad [ Equation 1 ]$$

$${E}_{Session , gNB} = {E}_{gNB} \frac{{DV}_{Session , gNB}}{{DV}_{gNB}}$$

$${E}_{Flow , gNB} = {E}_{gNB} \frac{{DV}_{Flow , gNB}}{{DV}_{gNB}}$$

The EIF 180 may calculate the energy consumption information about the energy consumed in the UPF 140 during a time period T by the UE, the PDU session, and the QoS flow.

$${E}_{UE , UPF} = {E}_{UPF} \frac{{DV}_{UE , UPF}}{{DV}_{UPF}} \qquad [ Equation 2 ]$$

$${E}_{Session , UPF} = {E}_{UPF} \frac{{DV}_{UE , UPF}}{{DV}_{UPF}}$$

$${E}_{Flow , UPF} = {E}_{UPF} \frac{{DV}_{Flow , UPF}}{{DV}_{UPF}}$$

The EIF 180 may calculate energy (or the energy consumption information) (e.g., E_{UE}) consumed in the network by the UE during the time interval T through Equation 3.

$${E}_{UE} = {\sum }_{{gNB}_{i} ∈ {gNB}_{UE}^{T}} {E}_{UE , {gNB}_{i}} + {\sum }_{{UPF}_{i} ∈ {UPF}_{UE}^{T}} {E}_{UE , {UPF}_{i}} \qquad [ Equation 3 ]$$

In this case,

$${gNB}_{UE}^{T}$$

may denote all gNBs used by the UE during the time interval T, and

$${UPF}_{UE}^{T}$$

may denote all UPFs used by the UE during the time interval T.

The EIF 180 may calculate energy (e.g., E_{Session}) consumed in the network by the PDU session during the time interval T through Equation 4.

$${E}_{Session} = {\sum }_{{gNB}_{i} ∈ {gNB}_{Session}^{T}} {E}_{Session , {gNB}_{i}} + {\sum }_{{UPF}_{i} ∈ {UPF}_{Session}^{T}} {E}_{Session , {UPF}_{i}} \qquad [ Equation 4 ]$$

In this case,

$${gNB}_{Session}^{T}$$

may denote all gNBs used by the PDU session during the time interval T, and

$${UPF}_{Session}^{T}$$

may denote all UPFs used by the PDU session during the time interval T.

The EIF 180 may calculate energy (e.g., E_{UE}, E_{Session}, and E_{Flow}) consumed in the network by the QoS flow during the time interval T through Equation 5.

$${E}_{Flow} = {\sum }_{{gNB}_{i} ∈ {gNB}_{Flow}^{T}} {E}_{Flow , {gNB}_{i}} + {\sum }_{{UPF}_{i} ∈ {UPF}_{Flow}^{T}} {E}_{Flow , {UPF}_{i}} \qquad [ Equation 5 ]$$

In this case,

$${gNB}_{Flow}^{T}$$

may denote all gNBs used by the QoS flow during the time interval T, and

$${UPF}_{Flow}^{T}$$

may denote all UPFs used by the QoS flow during the time interval T.

FIG. 4 is a diagram illustrating a process of providing energy consumption information according to an embodiment.

The EIF 180 may collect UE-related energy consumption information. The EIF 180 may collect the UE-related energy consumption information from an OAM 190 and/or a 5GC NF 330. For example, the UE-related energy consumption information may include node-level energy (or energy consumption information) (e.g., energy consumed in the UPF 140 and energy consumed in the gNB), a node-level data volume, and a data volume of required granularities (or a required granularity level) (e.g., the UE, the PDU session, and/or the QoS flow). The EIF 180 may collect at least one of the node-level energy and/or the node-level data volume from the OAM 190. The EIF 180 may collect the data volume of required granularities (e.g., the UE, the PDU session, and/or the QoS flow) from the 5GC NF 330. The 5GC NF 330 may be the UPF 140 (e.g., via the SMF 130).

The SMF (or a serving SMF) 130 may be retrieved from the UDM 189 of the UE 100 based on input parameters (e.g., including at least one of UE identifier (ID), single network slice selection assistance information (S-NSSAI), and a data network name (DNN)).

The EIF 180 may provide UE ID, DNN/S-NSSAI, and IP 5-tuple to retrieve data or information from the SMF 130. The information that the EIF 180 collects from the SMF 130 may be the information shown in Table 3. In other words, the information of Table 3 may be information collected from the SMF 130 for calculation of energy consumption information (e.g., the user-plane energy consumption information) (user-plane energy consumption calculation).

A reporting period (e.g., a data volume reporting period) from the SMF 130 may be a PLMN-wide configurable period T.

TABLE 3

| Information | Description |
|---|---|
| UE IP address | UE IP address |
| UE ID | SUPI |
| S-NSSAI + | Slice and DNN applicable to a PDU session |
| DNN | |
| IP 5-tuple | IP 5-tuple |
| List of data | The data volume and the associated UPF(s) and |
| volume | gNB(s) serving the UE within the time period |
| information | |
| >UL/DL Data | The UL/DL Data Volume of a PDU Session identified |
| Volume of | by (UE-ID, S-NSSAI/DNN) or a QoS flow (UE ID, |
| UPF | S-NSSAI, DNN, IP 5-Tuple) |
| >(I-) UPF ID(s) | Identifier of any (I-)UPF(s) associated with a reported |
| | data volume used by a PDU Session identified by (UE- |
| | ID, S-NSSAI/DNN) or a QoS flow (UE ID, S-NSSAI, |
| | DNN, IP 5-Tuple) |
| >gNB serving the | The gNB which serves the UE |
| UE | |
| Time period | Time period of the collected information |

Table 4 may show received information from the OAM 190 for calculation of energy consumption information (e.g., the user-plane energy consumption information) (user-plane energy consumption calculation). The EIF 180 may send a request to the OAM 190 for the information by providing an identifier (e.g., serving gNB IDs and (I-)UPF IDs). The serving gNB IDs and (I-)UPF IDs may be provided by the SMF 130. A reporting period from the OAM 190 may be the same period T as the data volume reporting period from the SMF 130.

TABLE 4

| Information | Description |
|---|---|
| gNB energy | The energy consumed by a gNB over the configured |
| consumption | time period T. |
| gNB data volume | The UL/DL data volume handled by a gNB over the |
| | configured time period T. |
| UPF energy | The energy consumed by a UPF over the configured |
| consumption | time period T. |
| UPF data volume | Data volume consumed at a UPF. |

When the gNB and/or UPF (e.g., (I-)UPF) serving the UE is changed, the serving gNB ID and the UPF ID may be updated to the EIF 180 via the SMF 130.

The node-level energy consumption information received from the OAM 190 may be used by the EIF 180 for all UEs serving in an NF node.

The EIF 180 may calculate the energy consumption information in the unit of required granularities (e.g., the UE, the PDU session, and/or the QoS flow) based on the information (or energy information) described in Table 3 and/or Table 4. The operation of calculating the energy consumption information by the EIF 180 may be substantially the same as the method described with reference to FIG. 3. Accordingly, a detailed description thereof will be omitted.

The EIF 180 may provide the energy consumption information to a consumer NF 320.

The consumer NF 320 (e.g., the NF 230 of FIG. 3) may send a request (e.g., exposure of the energy information) for the energy information. The consumer NF 320 may include at least one of the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1.

The consumer NF 320 may subscribe to the EIF 180 for the energy consumption information of required granularities (e.g., the UE, the PDU session, and/or the QoS flow).

To expose UE-level energy (or energy consumption information), the consumer NF 320 may provide the UE ID (e.g., a subscription permanent identifier (SUPI) or generic public subscription identifier (GPSI)) to the EIF 180. A subscription request may include the UE ID (e.g., the SUPI or GPSI).

To expose PDU session-level energy (or energy consumption information), the consumer NF 320 may provide the UE ID (e.g., the SUPI or GPSI) and DNN/S-NSSAI to the EIF 180. The subscription request may include the UE ID (e.g., the SUPI or GPSI) and DNN/S-NSSAI.

To expose QoS flow-level energy (or energy consumption information), the consumer NF 320 may provide the UE ID (e.g., SUPI or GPSI) and a flow description to the EIF 180. The subscription request may include the UE ID (e.g., SUPI or GPSI), DNN/S-NSSAI, and the flow description.

In addition, the consumer NF 320 may subscribe to information exposure (e.g., energy consumption information exposure) by providing a reporting period and a reporting frequency. The subscription request may include the reporting period and the reporting frequency.

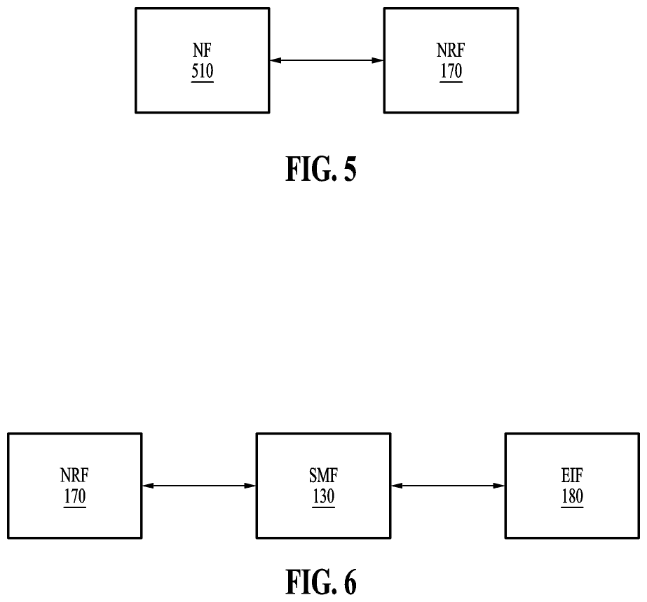

FIG. 5 is a diagram illustrating an example of the use of energy consumption information according to an embodiment.

The NRF 170 may register an NF 510. The NRF 170 may register an NF profile of the NF 510. The NRF 170 may register or maintain energy-related information of the NF 510 in the NF profile as a part of the NF profile. The energy-related information may be considered in a related procedure, such as NF service registration, NF service update, NF service retrieval, or NF state subscription/notification.

The energy-related information in the NF profile may include the following information defined in Table 5.

TABLE 5

| Information | Description |
|---|---|
| NF energy saving | This parameter indicates the energySavingstate will be applied to the |
| state information | NF and optionally the associated timing information (e.g., the NF will be |
| | in the energySaving state at a timestamp and/or for a time period). |
| Energy priority | This parameter indicates the priority relative to other NFs of the same |
| information | type by considering the energy characteristics of the NF and the energy |
| | saving state of the NF (NOTE 1). |
| Energy efficiency | Ratio of the NF service key performance indicator (KPI) (e.g., forwarded |
| | data volume of UPF) over the energy consumed in the NF. |
| Renewable energy | Ratio of the renewable energy to the total energy (see ISO/IEC 30134- |
| | 3: 2016) |

(NOTE 1): The energy priority information is operator-specific. Depending on the operator policy and configuration, the determination of the energy priority information may consider various energy characteristics of the NF, for example, by weighting of different energy characteristics. The energy characteristics may include one or list of: energy consumption, energy efficiency, renewable energy and/or carbon emission factors, etc.

For energy saving functionality, the NRF 170 may support information, such as energy consumption by an OAM, an energy consumption threshold, a proportion of renewable energy usage, and energy saving priority.

FIG. 6 is a diagram illustrating another example of the use of energy consumption information according to an embodiment.

The SMF 130 may select or reselect an UPF for PDU session setting, UE mobility or UE traffic offloading, or energy-efficient UPF selection. The SMF 130 may select and/or reselect the UPF by considering a UPF deployment scenario, such as a centralized UPF and a UPF distributed near or to an access network site.

The SMF 130 may select and/or reselect the UPF based on energy consumption information (e.g., energy consumption information of the UPF) provided by the EIF 180. The energy consumption information (e.g., the energy consumption information of the UPF) may also be provided by the OAM 190.

The SMF 130 may consider energy consumption information (e.g., the energy consumption information of the UPF) of an NF profile to select and/or reselect the UPF.

The SMF 130 may retrieve the UPF using the NRF 170 to select and/or reselect the UPF. The SMF 130 may send a request including a parameter to the NRF 170. The parameter may include a DNN, S-NSSAI, an SMF area identifier, a requested function and performance (e.g., an access traffic steering, switching & splitting (ATSSS) steering function, a function related to a high-speed data transmission low-latency service, a network address translation (NAT) information exposure function, an internet protocol (IP) or media access control (MAC) filter-based packet detection function, etc.) and the energy consumption information (e.g., the energy consumption information of the UPF). The SMF 130 may select, reselect, and/or control the UPF based on the energy-related information, such as energy consumption, an energy consumption threshold, a proportion of renewable energy usage, and an energy priority policy obtained from the NRF 170.

The SMF 130 may provide available UPFs 140 in the SMF 130 using the NRF 170. Provisioning may be performed before selecting the UPF for the PDU session. The UPF 140 may register to the NRF 170. This registration operation may use an Nnrf_NFManagement_NFRegister operation.

The SMF 130 may use an Nnrf_NFManagement_NFStatusSubscribe service operation, an Nnrf_NFManagement_NFStatusNotify service operation, and an Nnrf_NFDiscovery service operation to provide the available UPF. The UPF may be associated with UPF provisioning information in the NRF 170. The UPF provisioning information may include whether energy saving and efficiency functions (e.g., the energy consumption, the energy consumption threshold, and the proportion of renewable energy usage) are supported.

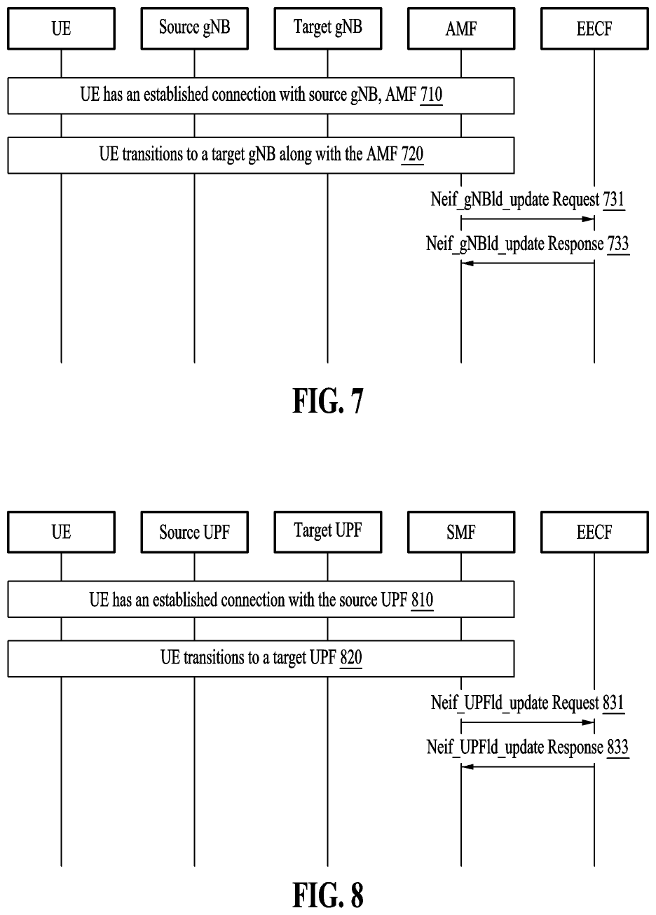

FIGS. 7 and 8 are diagrams illustrating an ID update procedure for an EIF when changing a network. The ID update update procedure may be a procedure triggered by an AMF or SMF to provide a gNB or UPF ID to an EIF when a network change, such as a handover, a QoS change, or network slice modification, occurs and affects a service of the UE, thereby requiring an update of the gNB or UPF.

The EIF service may be shown in Table 6.

TABLE 6

| | | | Consumer |
|---|---|---|---|
| Service name | Service operation | Operation semantics | example |
| Neif_gNBId | Update | Request/Response | AMF |
| Neif_UPFId | Update | Request/Response | SMF |

### Neif_gNBId_Update Service Operation

The Neif_gNBId_Update service operation may be a request by a consumer to the EIF in order to update a gNB ID of the UE in service due to the network change.
(1) Required inputs: gNB ID, SUPI, GUTI, PDU Session ID, UE Context ID
(2) Optional inputs: None
(3) Required Outputs: None

### Neif_UPFId_Update Service Operation

The Neif_UPFId_Update service operation may be a request by a consumer to the EIF in order to update a UPF ID of the UE in service due to the network change.
(1) Required inputs: UPF ID, SUPI, GUTI, PDU Session ID, UE Context ID
(2) Optional inputs: None
(3) Required Outputs: None

FIG. 7 is a diagram illustrating a gNB ID update trigger for an EIF when changing a network according to an embodiment.

In operation 710, a UE may be connected to a source gNB and an AMF.

In operation 720, the UE may be transferred to a target gNB and the AMF due to an event, such as a handover, a QoS change, or network slice modification.

In operation 731, the AMF may transmit a target gNB ID to the EIF via Neif_gNBId Request to maintain an EIF session to which energy saving and efficiency functions are applied.

In operation 733, the EIF may confirm that a new gNB ID has been updated.

FIG. 8 is a diagram illustrating an UPF ID update trigger for an EIF when changing a network according to an embodiment.

In operation 810, a UE may be connected to a source UPF.

In operation 820, the UE may be transferred to a target UPF and an SMF due to an event, such as a handover, a QoS change, or network slice modification.

In operation 831, the SMF may transmit a target UPF ID to the EIF via an Neif_UPFId Request to maintain an EIF session to which energy saving and efficiency functions are applied.

In operation 833, the EIF may confirm that a new UPF ID has been updated.

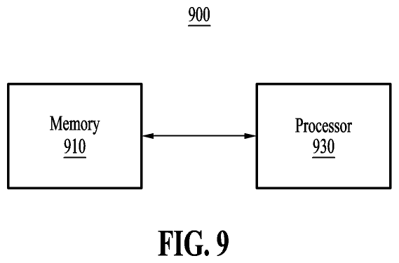

FIG. 9 is a schematic block diagram of a device according to an embodiment.

Referring to FIG. 9, according to an embodiment, a device 900 (e.g., a server device) may be substantially the same as at least one of the EIF (e.g., the EIF 180 of FIG. 1), the SMF (e.g., the SMF 130 of FIG. 1), and the NRF (e.g., the NRF 170 of FIG. 1) described with reference to FIGS. 1 to 8. The device 900 may include a memory 910 and a processor 930.

The memory 910 may store instructions (or programs) executable by the processor 930. For example, the instructions include instructions for performing the operation of the processor 930 and/or an operation of each component of the processor 930.

The memory 910 is implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and or insulator resistance change memory.

The processor 930 may execute computer-readable code (e.g., software) stored in the memory 910 and instructions triggered by the processor 930. The processor 930 may be a data processing device implemented by hardware including a circuit having a physical structure to perform desired operations. The desired operations may include, for example, code or instructions included in a program. A data processing device implemented by hardware may include, for example, a microprocessor, a CPU, a processor core, a multi-core processor, a multiprocessor, an ASIC, and an FPGA.

The operation performed by the processor 930 may be substantially the same as the operation of at least one of the EIF (e.g., the EIF 180 of FIG. 1), the SMF (e.g., the SMF 130 of FIG. 1), and the NRF (e.g., the NRF 170 of FIG. 1) described with reference to FIGS. 1 to 8. Accordingly, a detailed description will be omitted.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of serving energy information in a network, the method comprising:
collecting first user equipment (UE)-related energy consumption information from operation, administration, and maintenance (OAM);
collecting second UE-related energy consumption information from a fifth generation core (5GC) network function (NF);
calculating energy consumption information in a unit of required granularities based on the first UE-related energy consumption information and the second UE-related energy consumption information;
receiving a request for energy information from an NF consumer; and
providing the energy consumption information in the unit of required granularities to the NF consumer.

2. The method of claim 1, wherein the 5GC NF comprises at least one of a user plane function (UPF) and a session management function (SMF).

3. The method of claim 1, wherein a reporting period from the OAM is the same as a reporting period from the 5GC NF.

4. The method of claim 1, wherein the unit of required granularities comprises UE, a protocol data unit (PDU) session, and a quality of service (QoS) flow.

5. The method of claim 1, wherein the request comprises a reporting period and a reporting frequency.

6. A device for serving energy information in a network, the device comprising:
at least one processor including processing circuitry; and
memory storing instructions,
wherein the instructions, when executed individually or collectively by the at least one processor, cause the device to:
collect first user equipment (UE)-related energy consumption information from operation, administration, and maintenance (OAM),
collect second UE-related energy consumption information from a fifth generation core (5GC) network function (NF),
calculate energy consumption information in a unit of required granularities based on the first UE-related energy consumption information and the second UE-related energy consumption information,
receive a request for energy information from an NF consumer, and
provide energy consumption information in the unit of required granularities to the NF consumer.

7. The device of claim 6, wherein the 5GC NF comprises at least one of a user plane function (UPF) and a session management function (SMF).

8. The device of claim 6, wherein a reporting period from the OAM is the same as a reporting period from the 5GC NF.

9. The device of claim 6, wherein the unit of required granularities comprises UE, a protocol data unit (PDU) session, and a quality of service (QoS) flow.

10. The device of claim 6, wherein the request comprises a reporting period and a reporting frequency.
